(19) United States
(12) Patent Application Publication
(10) Pub. No.: US 2004/0078235 A1
(43) Pub. Date: Apr. 22, 2004

(54) System, method and apparatus for a direct point-of-service health care by a network provider

(75) Inventor: Joseph L. Tallal JR., Dallas, TX (US)

Correspondence Address: CHALKER FLORES, LLP, 12700 PARK CENTRAL, STE. 455, DALLAS, TX, 75251, US

(73) Assignee: Global Mining And Marketing, LLC, Dallas, TX

(21) Appl. No.: 10/620,904

(22) Filed: Jul. 16, 2003

Related U.S. Application Data
(60) Provisional application No. 60/396,883, filed on Jul. 17, 2002.

(51) Int. Cl. G06F 17/60

(52) U.S. Cl. 705/2

(57) ABSTRACT

The present invention provides a system, method and apparatus for direct point-of-service health care by a network provider. The system includes a network provider (204) that provides a health care plan, one or more medical service/good providers (206) that have joined the health care plan, one or more individuals (202) that are members of the health care plan and a discount price list (208) provided by the network provider (204) that regulates the cost of services/goods provided to the members (202) by the medical service/good providers (206) such that the members pay the medical service/good providers (206) in-full directly (212) for any services/goods rendered based on the discount price list (208).

This patent application claims priority to U.S. provisional patent application serial No. 60/396,883 filed on July 17, 2002.

### TECHNICAL FIELD OF THE INVENTION

The present invention relates generally to the field of health care management and, more particularly, to a system, method and apparatus for direct point-of-service health care by a network provider.

### BACKGROUND OF THE INVENTION

Without limiting the scope of the invention, its background is described in connection with the costs associated with obtaining medical care, as an example.

Medical practice and delivery have changed dramatically over the last few decades. Prior to the mid 1970's, medical services were offered by a physician to a patient with those two being the principal participants and decision makers in the process. Most primary and secondary care physicians owned their own businesses and made their own business decisions. A single physician practice often only consisted of him/herself, a receptionist/ secretary/ bookkeeper, and a nurse. Running the medical practice was a much simpler process as the physician, like any other form of small businessperson, only had to keep track of its appointments, book it services and reconcile the books. A doctor's overhead was often below 50% of gross revenues and sometimes below 40%. The bottom-line was a physician, like other small privately owned businesses, found themselves completely in control of their businesses and the masters of their own fate.

The patient on the other hand, also had a different relationship with their physician. Patients freely selected whom they saw and their medical treatment options were purely between them and their physician. Insurance for the patient was also quite different. To fully understand the insurance environment, look at the short excerpt taken from a typical financial plan in the 1970's, which explains the insurance options and how to make the best choices.

Health insurance can be broken down into three categories: Basic Hospitalization, Major Medical, and Excess Major-Medical. Many policies today are actually a hybrid of these three. If a choice had to be made between policies that only offered two out of the three, the Major Medical and Excess Major Medical are the most important.

Because Basic Hospitalization covers the “broken-bone and band-aid” type injuries, it is the most expensive health insurance you can buy. The purpose of health insurance in your financial plan should be to provide protection against catastrophic medical expenses that would spell disaster to the accomplishments of your financial goals. If it were a choice between just basic hospitalization or major medical, we recommend that you self-insure, by selecting a policy with a higher deductible, for the incidental injuries that would otherwise be covered under the Basic Hospitalization policy.

We do not show that you have a major medical policy and therefore recommend that you acquire one. We usually suggest a good basic policy that has a $300.00-$500.00 deductible which covers at least 80% of the next $2,000.00, with 100% coverage of the balance up to $25,000.00. This coverage combined with the excess major medical discussed below will provide a secure program.

The final type of health insurance to consider is Excess Major-Medical. This can be the most protective insurance you can buy, while being the least expensive. Even after you acquire your new major medical policy, a radical illness or accident could threaten total financial disaster. We, therefore, recommend that you obtain the relatively inexpensive Excess Major-Medical insurance with a $10,000.00 deductible, and a maximum coverage of $1,000,000.00.

If this advice is compared with the types of insurance available today, you will see that it can no longer be implemented. The types of products have evolved so dramatically that following the basic financial advice of self insuring for small occurrences (what you can afford to pay) and obtaining maximum coverage to protect against the large expenses that would severely impact your finances can no longer be implemented. In other words, the old adage of don't try to trade dollars with an insurance company (premium vs. coverage), because the odds are overwhelming stacked against you, is no longer an option.

A review of the last 30 years reveals how this evolution occurred. First, the government, through Medicare, started with the hospital based physicians (the pathologist and anesthesiologist) and set a ceiling on what they could charge Medicare for their services. While this hobbled these physician specialties, instead of banding together, the other physician specialties breathed a sigh of relief because they were not the targets of this attack. And so it went, change after change made through Medicare in a divide and conquer process, with physicians as a whole standing by doing nothing, because it wasn't affecting them previously in the most current go round.

Next the major medical insurance companies followed suit. They figured if Medicare could do it, so could they, and they were right. “Usual and customary fees” became a standard and doctors lost another part of their autonomy.

The introduction of Health Maintenance Organizations (“HMO”) began the era of corporately practiced medicine. Large corporations hired doctors on salaries and provided their services to patients under a plan where everything was covered for a set fee. The only problem was that the patient has to see the HMO's doctor when he or she was available and the patient was very restricted in what the HMO would allow the doctor to prescribe. As an employee answering to a company, the HMO doctor no longer had the choice of what should or should not be done. The subsequent horror stories concerning HMO abuses have become legendary.

In the 1980's, there was the widespread introduction of a new concept, the Preferred Provider Organization (“PPO”). The PPO ushered in a new era that has once again revolutionized the way medicine is offered and practiced. The PPO signed-up initially new physicians that were trying to build their practices by offering to send them a large quantity of patents in exchange for a substantial discount. PPOs became integrated quickly with normal major medical coverage, offering a new form of coverage that allowed the patient to select their physician from a list and see the doctor for a set fee, usually $10.00, with the insurance company paying the excess.

Similar to the way a drug dealer often gives away small samples to get a new user hooked, the PPO did the same thing. In the beginning, a patient could walk into their doctor's office and anything done during that visit was free above the $10.00 co-pay fee. If a doctor did a surgical procedure in his office, the cost to the patient was still only $10.00.

The doctors quickly found themselves having to join PPOs, because their patients all wanted to see doctors that only cost them the $10.00 co-pay. In a very short time, almost all doctors in the country found themselves with a principally PPO based patient practice, which created several new problems. First, in order to maintain a comparable income, doctors had to start seeing a much greater quantity of patients because they were receiving less for their services. Second, the doctors had to get pre-approval from the PPO for the services they wanted to provide their patients. Insurance employees quickly became the decision makers of what a patient needed instead of the doctor (shades of the same problem the HMO physicians were facing). Third, the PPO became a quagmire of procedures that the doctors were required to follow in order to be paid. As time progressed, the insurance companies made it more difficult for the doctors to receive their payments and doctors who once had a 2-3 person office, found themselves needing 2-3 more employees, just to process insurance claims.

Over the last 15-20 years, PPOs have become integrated with most forms of medical insurance. The insurance companies gradually reduced what was covered for the patient by their office co-payment, pushing more and more into what needed to be covered by the policy, which was subject to deductibles. At the same time, the insurance companies started reducing what they were willing to pay the physicians for their services. Today, physicians and laboratories receive only a small fraction of what they normally receive for their services for non-PPO patients. The following are recent actual examples of what is paid for services by a PPO vs. what the normal charges for the service was billed; the difference is called the PPO Discount.

| | AMOUNT | PPO | AMOUNT |
|---|---|---|---|
| SERVICE PREFORMED | CHARGED | DISCOUNT | PAID |
| OUT-PATIENT SURGERY | $1,158.00 | $792.35 | $385.65 |
| DIAGNOSTIC X-RAY | $1,126.00 | $576.00 | $550.00 |
| EXAMINATION | $81.00 | $28.72 | $52.28 |
| IMMUNIZATION | $25.00 | $15.03 | $9.97 |
| IMMUNIZATION | $40.00 | $33.00 | $7.00 |
| DIAGNOSTIC LAB | $73.62 | $68.52 | $5.10 |
| EQUIPMENT/SUPPLIES | $275.00 | $164.00 | $74.00 |
| EQUIPMENT/RENTAL | $250.00 | $200.00 | $50.00 |
| VISION EXAM | $75.00 | $57.00 | $15.00 |
| DIAGNOSTIC X-RAY | $1,900.00 | $475.00 | $1,425.00 |

While the amounts paid to physicians have continually decreased, the amount of the premium paid by the insured has been escalating at unprecedented percentages, often 50% or more per year. The deductible amounts are being forced up because the insured can no longer afford the previous lower amounts. An example of such was a premium increase last year from $945.00 per month to $1,394.00 per month for a $500.00 deductible on a 50-year-old insured with a family of three. The only way the insured could keep the premium down was to greatly reduce the benefits so that the premium increased to only $1,038.00 per month. But look at the real cost to the insured. Last year's deductible was $500.00 per person with an 80%/20% co-pay for In-Network Providers and 70%/30% for Out-of-Network Providers with a maximum Family Out-of-Pocket Limit of $3,500.00 In-Network and $7,500.00 Out-of-Network. This years' deductible increased from $500.00 to $2,000.00 per person with an 80%/20% co-pay for In-Network Providers and 60%/40% for Out-of-Network Providers with a maximum Family Out-of-Pocket Limit of $15,000.00 (vs. $3,500.00) In-Network and $48,000.00 (vs. $7,500.00) Out-of-Network.

For example, FIG. 1 depicts a diagram illustrating a PPO plan and major medical coverage 100 provided by an insurance company 102 in accordance with the prior art. The prior art includes an insurance company 102, one or more individuals 104 either individually or part of a group and one or more service or product providers 106. The individual 104 pays a premium 108, which includes enrollment in a PPO Plan and major medical coverage, to the insurance company 102. All or part of the premium 108 may be paid by the individual's 104 employer or business. The premium 108 may also include coverage for a spouse and dependents. When an individual 104 or a family member obtains health/medical services or products from a service/product provider 106, the individual 104 typically pays a co-pay to the service/product provider 106 when the services or products are covered by the PPO Plan. If, however, the service or product is not covered by the PPO Plan, but is covered by the major medical coverage, the individual 104 typically pays a deductible up to a maximum out-of-pocket expense limit. The insurance company 102 then pays the service or product provider 106 based on contractual price list (PPO Fee) or what is deemed as usual and customary charges (Major Medical Payment) for the product or service in the particular geographic area (collectively shown as 112). Note that there can be a significant delay and administrative overhead associated with obtaining payment 112 from the insurance company 102.

### SUMMARY OF THE INVENTION

There currently appears an unprecedented opportunity to have a significant influence on the medical services industry in this country and capture a large portion of that industry's business while providing both the doctors and patients of that industry a clear benefit. A direct point-of-sale system that includes a network of one or more medical service providers, such as physicians, hospitals, physical therapists, nursing facilities, cancer treatment centers, optical and hearing aid dispensaries hospices, and clinics; one or more customers having access to the network of one or more physicians; a variable discount price list that tracks a known standard service price list that regulates the cost of services provided to the customers by the physicians and wherein the customer pays the network of physicians in-full directly for any services rendered based on the variable discount price list; and wherein new customers are provided access to each other via a referral network that provides incentives within a multi-level network.

The direct point-of-sale system may include that the service provider is a medical service provider, e.g., physicians, hospitals, physical. therapists, nursing facilities, cancer treatment centers, hearing aid dispensaries, hospices, and clinics. The network of physicians may be provided through a global telecommunications network. To allow for a more user-friendly environment, the referral network of physicians may be sorted by, e.g., geographic area and physicians may be sorted by, e.g., health care specialty. The provider listing may be divided further into a premium and a basic listing class. The premium listing may include, e.g., a customizable page on a global telecommunications network.

The present invention provides a system that includes a network provider that provides a health care plan, one or more medical service/good providers that have joined the health care plan, one or more individuals that are members of the health care plan and a discount price list provided by the network provider that regulates the cost of services/goods provided to the members by the medical service/good providers such that the members pay the medical service/good providers in-full directly for any services/goods rendered based on the discount price list.

Moreover, the present invention provides a method for providing a health care plan wherein a membership fee is received from one or more individuals to become members of the health care plan, information is obtained from one or more medical service/good providers that have joined the health care plan and a discount price list is provided that regulates the cost of services/goods provided to the members by the medical service/good providers such that the members pay the medical service/good providers in-full directly for any services/goods rendered based on the discount price list. This method can be implemented as a computer program embodied on a computer readable medium wherein the steps are implemented by code segments.

In addition, the present invention provides an apparatus for providing a health care plan that includes a server, one or more storage devices communicably coupled to the server and a communications interface communicably coupled to the server that allows a member to access the discount price list. The one or more data storage devices contain a discount price list that regulates the cost of services/goods provided to a member of the health care plan by a medical service/good provider such that the member pays the medical service/good provider in-full directly for any services/goods rendered based on the discount price list. The member is an individual that has paid a membership fee to join the health care plan.

The present invention also provides a direct point-of-sale system that includes a listing for a service provider within a network of service providers, wherein the listing is divided into a basic and a premium listing. Similarly, the present invention provides a direct point-of-sale system that includes a referral network of service providers divided into a premium and a basic listing and wherein the premium listing includes a customizable page in a server with access to a global telecommunications network.

In addition, the present invention provides a customer service network that includes a service provider network comprising two or more medical service providers, a customer network comprising two or more customers, a server comprising the information of the medical service provider network and the customer network and a variable discount price list that tracks a known standard payment list available to both the medical service provider network and the customer network, wherein the customer pays the health care service provider in-full directly for any services rendered based on the variable discount price list.

Furthermore, the present invention provides a patient referral system on a global telecommunications network that includes a first database that comprises a customer network, a second database that comprises a medical service providers network, a third database that comprises a variable discount service price list that tracks a known standard medical service provider payment schedule and a web-page that a customer can access to identify a medical service provider and the price list. The customer pays the medical service provider in full at the point-of-service.

### BRIEF DESCRIPTION OF THE DRAWINGS

For a better understanding of the invention, and to show by way of example how the same may be carried into effect, reference is now made to the detailed description of the invention along with the accompanying figures in which corresponding numerals in the different figures refer to corresponding parts and in which:

FIG. 1 is a diagram illustrating a PPO plan and major medical coverage provided by an insurance company in accordance with the prior art;

FIG. 2A is a diagram illustrating a PPO plan provided by a network provider in accordance with one embodiment of the present invention;

FIG. 2B is a diagram illustrating an insurance company providing only major medical insurance coverage to supplement the PPO plan provided in accordance with the present invention;

FIG. 3 is a data flow diagram in accordance with one embodiment of the present invention;

FIG. 4 is a flow chart showing the overall process in accordance with one embodiment of the present invention;

FIG. 5 is a revenue flow chart in accordance with one embodiment of the present invention;

FIG. 6A is a flow chart showing the steps performed by a network provider in accordance with one embodiment of the present invention (FIGS. 2A and 7);

FIG. 6B is a flow chart showing the steps performed by a service or good provider in accordance with one embodiment of the present invention (FIGS. 2A and 7);

FIG. 6C is a flow chart showing the steps performed by a member in accordance with one embodiment of the present invention (FIGS. 2A and 7);

FIG. 7 is a diagram illustrating a PPO plan provided by a pharmacy network provider in accordance with another embodiment of the present invention;

FIG. 8 is a diagram illustrating a PPO plan provided by a pharmacy benefit manager in accordance with another embodiment of the present invention;

FIG. 9A is a flow chart showing the steps performed by a pharmacy benefit manager in accordance with another embodiment of the present invention (FIG. 8);

FIG. 9B is a flow chart showing the steps performed by a pharmaceutical company in accordance with another embodiment of the present invention (FIG. 8);

FIG. 9C is a flow chart showing the steps performed by a member in accordance with another embodiment of the present invention (FIG. 8);

FIG. 10 is a diagram illustrating a PPO plan and major medical plan provided by an insurance company in accordance with another embodiment of the present invention;

FIGURE 11A is a flow chart showing the steps performed by an insurance company in accordance with another embodiment of the present invention (FIG. 10);

FIG. 11B is a flow chart showing the steps performed by a service or good provider in accordance with another embodiment of the present invention (FIG. 10); and

FIG. 11C is a flow chart showing the steps performed by a member in accordance with another embodiment of the present invention (FIG. 10).

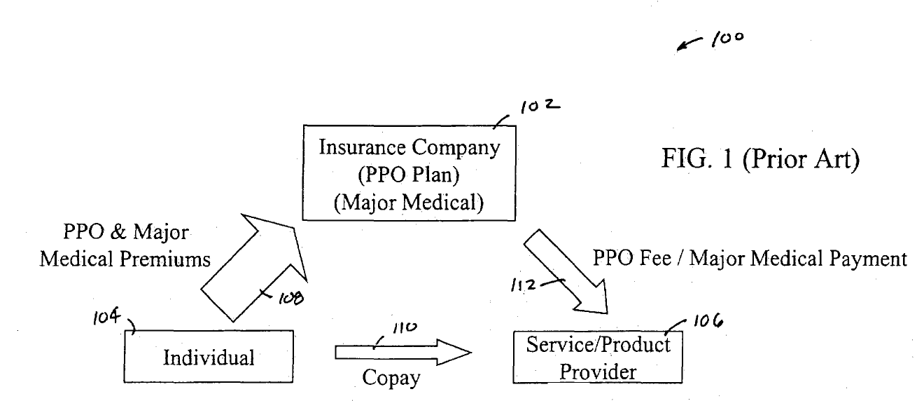

### DETAILED DESCRIPTION OF THE INVENTION

While the making and using of various embodiments of the present invention are discussed in detail below, it should be appreciated that the present invention provides many applicable inventive concepts that may be embodied in a wide variety of specific contexts. The specific embodiments discussed herein are merely illustrative of specific ways to make and use the invention and do not delimit the scope of the invention.

The solution in the case of health care/medicine is to cut the PPO back out of the system. Both the physicians and the major medical insurance consumer now fully understand that there is no such thing as a free lunch. What looked good in the beginning has turned out to be nothing more than letting a great number of intermediaries interject themselves between the service provider and the patient. These intermediaries profit at the expense of the service providers and the patient, and control the delivery of medical services to the patient.

The present invention, also referred to as “PPO BUSTERS”, is a system and method that coordinates the interaction between patients, physicians and other service providers. Using the present invention, the system, method and apparatus requires nothing more than properly educating both the physician and the insured as to the real problem and offering them a viable solution. The system, method and apparatus of the present invention may be implemented by or on behalf of, e.g., individuals, groups of individuals, organizations (e.g., trade unions), corporations, government agencies, individual or groupings of states or state organizations, self-insured organizations or corporations, or groupings thereof.

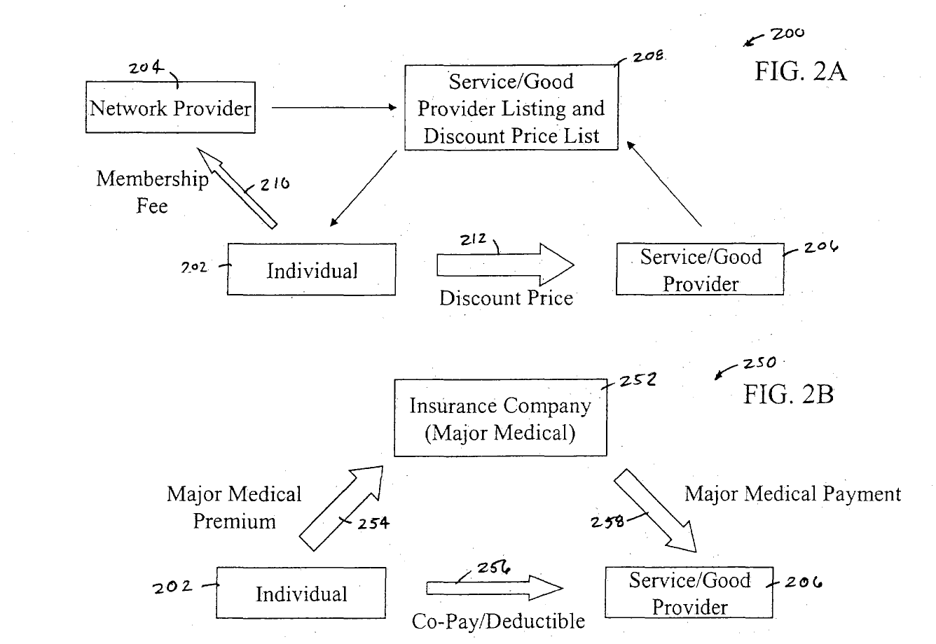

PPO BUSTERS is a private organization to which any person living in a specific geographical area can join. The small annual membership fee will be extremely reasonable considering the benefits that membership provides. Membership benefits will include being able to make appointments with medical service providers in their community and receiving their services at a greatly reduced cost (the same prices that a PPO pays the medical services provider). Because the member will have access to basic medical services at a reasonable cost (which they can afford), there won't be the need for them to buy expensive global medical insurance that pays for every visit to the doctor's office. Instead, a member may acquire a high-deductible major medical policy that provides excellent coverage for problems for which they really need medical insurance (see FIG. 2B).

For example, FIG. 2A depicts a diagram illustrating a PPO plan 200 (PPO BUSTERS) provided by a network provider 204 in accordance with one embodiment of the present invention. PPO BUSTERS 200 includes a network provider 204, individuals (members) 202 and medical service/good providers 206. As previously described, individuals 202 pay a membership fee 210 to the network provider 204 and/or PPO BUSTERS in order to join the program and access the medical service/good provider listing and discount price list 208. All or part of the membership fee 210 may be paid by the individual's 202 employer or business. The membership fee 210 may also include coverage for a spouse and dependents. The medical service/good provider listing 208 is created and maintained by the network provider 204 or its agents and contains, in part, information provided by the medical service/good providers 206. The medical service/good providers 206 provide this information to the network provider 204 when they join PPO BUSTERS by agreeing to the terms and conditions of the network provider 204, such as agreeing to only charge individuals 202 of PPO BUSTERS the discount price 212. The individual 202 pays the discount price 212 to the medical service/good provider 206 when the goods or services are rendered. The individual 202 can “look up” the discount price on the discount price list 208 prior to contacting the medical service/good provider 206.

The medical service/good providers 206 include physicians, hospitals, physical therapists, nursing facilities, cancer treatment centers, optical and hearing aid dispensaries, hospices, clinics, pharmaceutical benefit managers (“PBM”), pharmacies, chiropractors, dentists, medical supply stores, hospital supply stores and handicap equipment suppliers. As used herein the term “corporation” is used to refer to for-profit, non-profit, chartered and other organizations, including government entities, which may administer or be clients of the PPO Busters network.

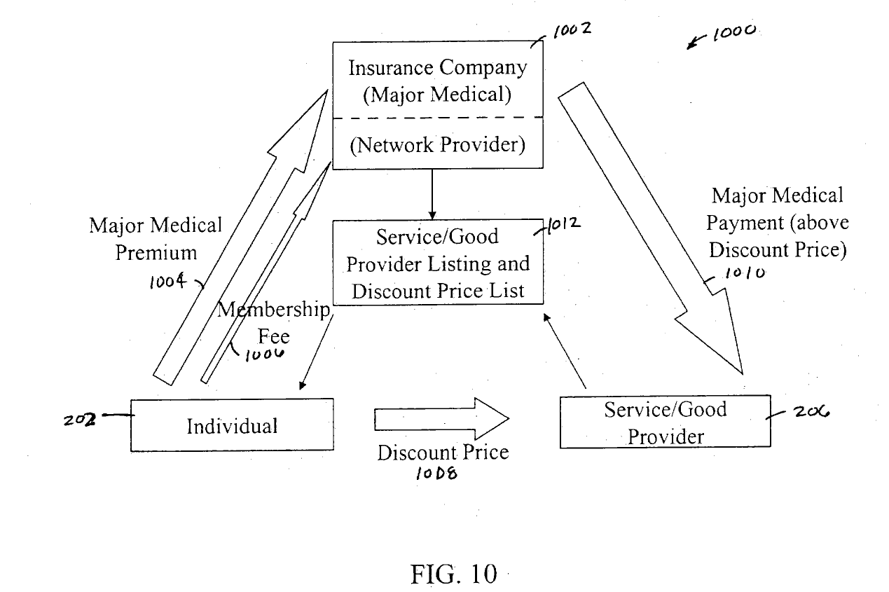

Members of PPO BUSTERS can obtain major medical insurance either on their own or through independent insurance companies that PPO BUSTERS has analyzed and selected. Such companies will be continually analyzed and compared to other companies that wish to compete for the business of PPO BUSTERS' members. Once an insurance company is approved, all dealings regarding the major medical insurance can be done directly between the member and the insurance provider so that PPO BUSTERS is not providing insurance that would be subject to state regulation. Naturally, this would not be an issue if PPO BUSTERS was implemented by an insurance company or someone that was not concerned about being subject to state regulation (see FIG. 10).

For example, FIG. 2B illustrates an insurance company 252 providing only major medical insurance coverage 250 to supplement the PPO BUSTERS plan 200 provided in accordance with the present invention. This supplement to PPO BUSTERS includes an insurance company 252, one or more individuals (members) 202 either individually or part of a group and one or more medical service/product providers 206. The individual 202 pays a major medical premium 254 to the insurance company 252. All or part of the premium 254 may be paid by the individual's 202 employer or business. The premium 254 may also include coverage for a spouse and dependents. When an individual 202 or a family member obtains health/medical services or products from a medical service/product provider 206, the individual 202 pays a co-pay/deductible 256 up to a maximum out-of-pocket expense limit. The insurance company 252 then pays the medical service/product provider 206 based on what is deemed as usual and customary charges (Major Medical Payment 258) for the product or service in the particular geographic area. Note that there can be a significant delay and administrative overhead associated with obtaining payment 258 from the insurance company 252.

The larger PPO BUSTERS membership roles become, the better the group premium 254 will become for its members. The bottom-line is that such insurance, without a mandatory PPO option, will only cost a fraction of what a normal medical insurance policy costs today because the insurance company 252 will not be responsible for the majority of the claims that current insurance companies pay. While the individual 202 will pay for their basic medical needs at greatly reduced prices 212 (FIG. 2A) (the same that PPO's are currently paying), their overall cost of medical services (insurance, co-pays and deductibles) will go down dramatically because they are no longer being forced to let the insurance company 252 make its profit spreads on every dollar spent for medical services. Moreover, healthy people will pay even less when compared to a current group health insurance premium. Over time, the savings can be tremendous for young healthy people, because health care expenses are shifted from present day dollars to future dollars. In addition, the young healthy people are not subsidizing those that are less healthy.

Each member of PPO BUSTERS will once again be able to follow the sound financial advice of self insuring for small occurrences (what they can afford to pay) and obtaining maximum coverage to protect against the large expenses that would severely impact their finances. In other words, they will be able to follow the old adage of not trying to trade dollars with their insurance company and put the odds back in their own favor.

Why would a physician be willing to offer an individual patient the same price as the high volume PPO? It doesn't take much talking with a physician to uncover how open a wound the loss of their business independence has become. What the PPO BUSTERS system, method and apparatus provides a doctor is the opportunity to receive the same amount of revenue received currently for each procedure from the PPO, but instead, receive it directly from the patient without having to wait 90-180 days to collect it. Since the patient will pay for all services as soon as they are rendered by check or credit card, the need for 3-4 employees just to process insurance claims can be reduced back to the way it was prior to PPO's. Additionally, a physician will once again be in the driver's seat with regards in determining what is best for the patient. In other words, an insurance company will not be second guessing or controlling every decision that the doctor makes.

Obviously, a physician who accepts PPO BUSTERS members will not be able to immediately cancel his contracts with the PPO's with whom he or she works. But instead, the doctor will begin the process of rebuilding a patient based practice until it has grown significantly enough to wean back off the PPO. Give a doctor the opportunity to regain the control of his practice and you have offered him or her something that many think was lost forever.

Building a program such a PPO BUSTERS could be a slow and monumental task if carried out with traditional business methodologies. However, PPO BUSTERS plans to combine many unique concepts, which will greatly hasten the process.

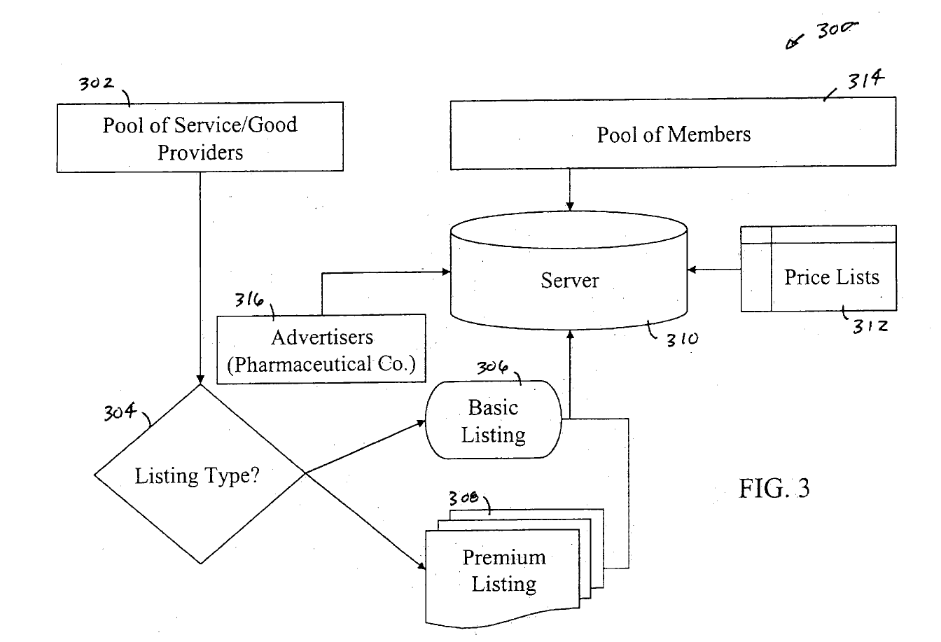

Now referring to FIG. 3, a data flow diagram 300 in accordance with one embodiment of the present invention is shown. The medical service/good providers 302 that wish to participate in the PPO BUSTERS program will be able to do so in one of two ways; either by obtaining a Basic Listing 306 or a Premium Listing 308, as illustrated by decision block 304. A basic listing 306 is defined generally as being free to the participant and a premium listing 308 is defined generally as including a payment for the advertising services associated with the premium listing 308. The basic listing 306 may include, for example, general information about the medical service/good provider 302, such as name, address, phone number, office hours and minimal practice description, etc. The premium listing 308 may include in addition to the general information, for example, a link on a global telecommunications network to a medical providers special PPO BUSTERS web-page or a pre-stored advertising. The web-page will be a standardized layout that displays a picture of the provider, the provider's mission statement, a short biography, a picture of their facility, maps to the facility, etc. This web-page will be a way for a PPO BUSTERS member 314 to become more familiar with the medical service/good providers 302 offered and help them make a more informed choice. In essence, it is a way for the medical service/good provider 302 to advertise themselves. A portion of the payment for the premium listing 308 may enter a multi-level or network advertising payment system. The basic listings 306 and premium listings are stored on a server 310. The server 310 may be a single computer, data storage device or a distributed network of computers that allow appropriate access to the information stored on the server 310.

After the median PPO rate for a particular community has been determined, a price list 312 containing the published rates of services will be made available via the server 310. The term published rates does not necessarily mean that all rate information is public information available to everyone. For example, the published rates for one community may not be available to members 314 or medical service/good providers 302 in another community. If a medical service/good provider 302 wishes to offer PPO BUSTERS members 314 its services, the provider may sign an agreement to do so at the published fees and obtain a free Basic Listing 306 on the PPO BUSTERS Internet website via server 310. When a PPO BUSTERS member 314 wishes to find a provider 302 in their area, they will go to the PPO BUSTERS Internet website via server 310 and input their zip code and desired services category, at which point all the medical services providers 302 signed up with PPO BUSTERS in their area will be displayed. The PPO BUSTERS Internet website may also include information and advertisements from advertisers 316, such as pharmaceutical companies. The advertisements can be provided to the members 314 based on stored preferences, search terms or search results.

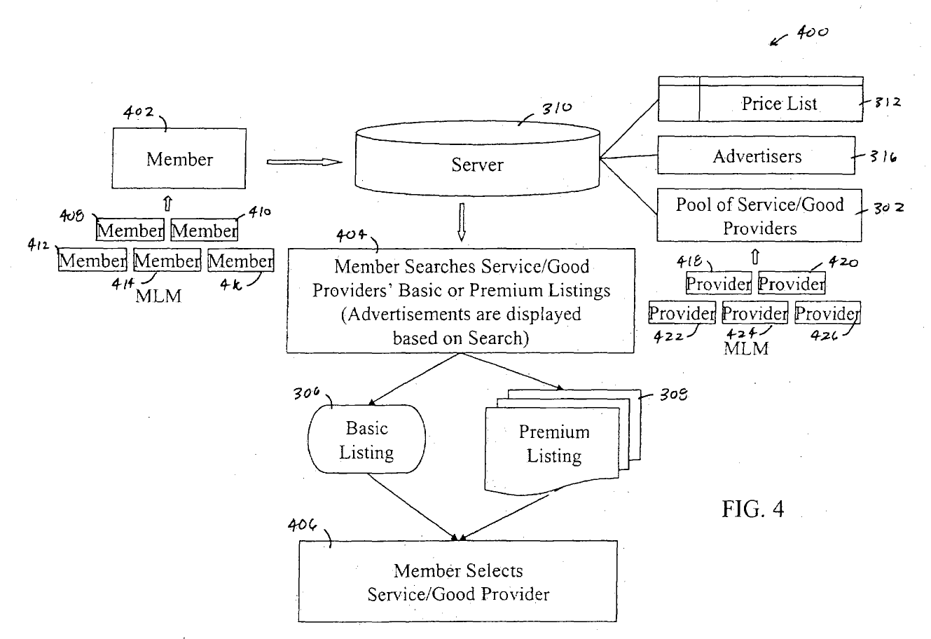

As shown in FIG. 4, the PPO BUSTERS system, method and apparatus 400 may be integrated into an existing multi-level marketing company, with a large existing base of potential members and/or an insurance company, which see the value of PPO BUSTERS vision and is not currently involved with a PPO. The system 400 may include charging a membership fee to the PPO Busters members 402, 408, 410, 412, 414 and 416 much of which may be paid into a MLM marketing network or matrix, so that members that wish, can build substantial new businesses that can provide for their long term financial security. A portion of the membership fee may also be paid to PPO BUSTERS. The benefits of a MLM marketing system are known and understood. A MLM marketing network may also be provided to the medical service/good providers 302, 418, 420, 422, 424 and 426.

As previously described, the server 310 contains price list information 312, information from advertisers 316 and information about the pool of medical service/good providers 302. A member 402 accesses the server 310 and searched the medical service/good providers' basic 306 and/or premium listings 308 in block 404. Advertisements can be displayed to the member 402 based on the search. Once the member 402 reviews the basic listings 306 and premium listings 308, the member 402 selects a medical service/good provider 302 in block 406.

A premium listing 308 may cost the medical service/good provider 302, e.g., $500.00 per year, much of which may be paid into a MLM marketing matrix. Medical service/good providers 302 who obtain premium listing 308 may automatically be enrolled in the PPO BUSTERS MLM marketing plan. The faster the medical provider network grows the easier it will be to expand PPO BUSTERS membership roles. One of the faster ways to build a medical providers network would be to compensate the medical service/good providers 302 who share the PPO BUSTERS program with other medical service/good providers 418, 420, 422, 424 and 426 that also face the same problem PPO problems and have a common goal of regaining their practices. With a reoccurring $500.00 listing fee, the MLM compensation side of the model for a medical service/good provider 302 will not be something that will be easily dismissed. Medical service/good providers 302 could also display information about PPO Busters at their receptionist desk and in their waiting area. Because of the PPO's, most medical service/good providers 302 have experienced a reduction in net income and many are looking for additional way to increase their take-home revenue. PPO BUSTERS offers an easy natural way for medical service/good providers 302 to increase substantially their revenue. PPO BUSTERS may also provide members with identification cards and other benefits, such as network dispute resolution services, specials and discounts on third party goods and services.

The Premium Listing 308 web-pages may be generated by an automated system that will let the listing medical service/good provider 302, e.g., fill in the blank sections and upload JPEG images that are incorporated in the standard PPO BUSTERS premium listing format. Off the shelf software is available that accommodates this function for PPO Busters.

The basic listings 306 and premium listings 308 for providers, pharmacies, or drugs may be displayed on a computer screen on the Internet, with the list looking like a telephone directory listing, with a list of provides displayed in a vertical line format. The basic listings 306 may be in regular case black font and the premium listings 318 may be in a larger hyperlink font of a different color so that when the hyperlink is clicked with a mouse, it takes them to a pop-up advertising page of the vendor, provider or manufacturer. The direct point-of-sale system may include a referral network of pharmacies divided into premium listings 308 and basic listings 306, wherein the premium listing 308 could also be sold to pharmacies so they could compete head to head with other pharmacies in the network, and may include a customized page on a global telecommunications network and wherein the customizable page further include one or more advertising links to an advertiser 316, e.g., a vendor, a service provider, a drug manufacturer or any other entity that wants to advertise to the members 402.

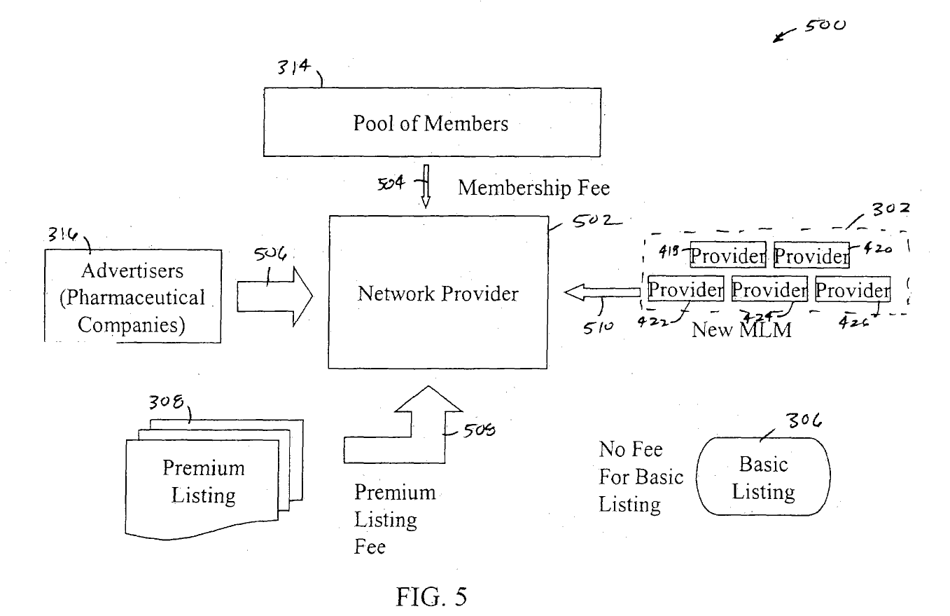

Now Referring to FIG. 5, a revenue flow chart 500 in accordance with one embodiment of the present invention is shown. The network provider 502 or PPO BUSTERS receives revenue from the pool of members 314 through membership fees 504, advertisers 316, such as pharmaceutical companies, through advertising fees 506, and medical service/good providers 302 for premium listings 308 through premium listing fees 508. There is no charge to medical service/good providers 302 for basic listings 306. Additional revenue 510 may also be obtained through a new MLM of medical service/good providers 418, 420, 422, 424 and 426.

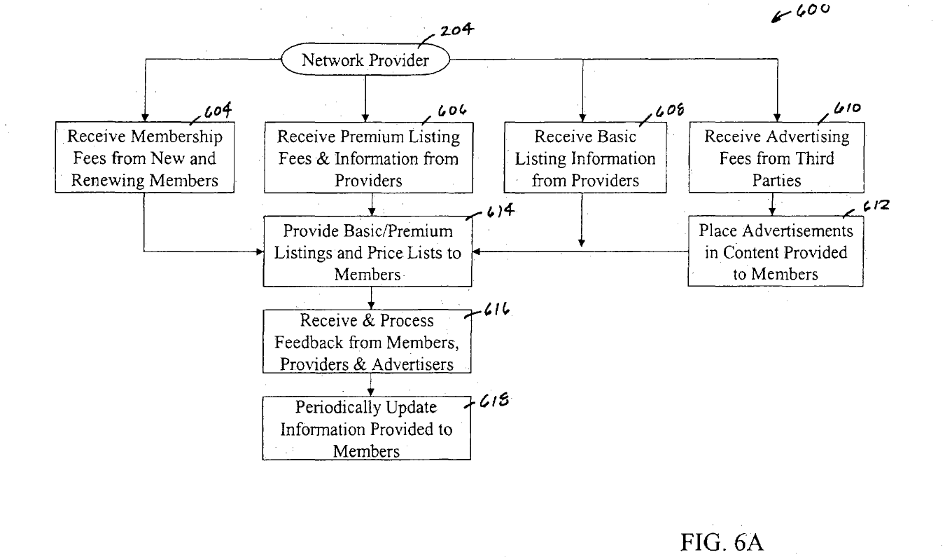

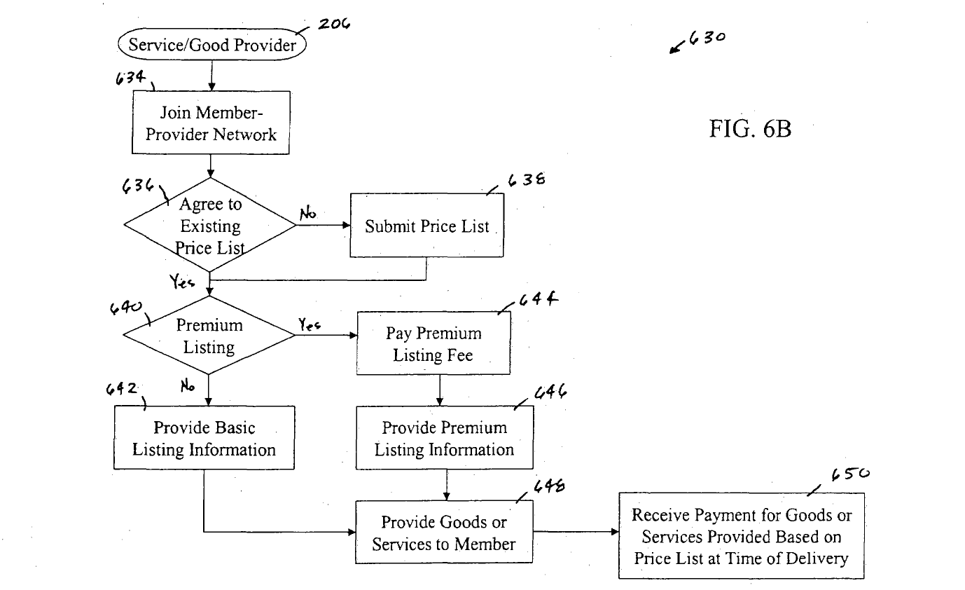

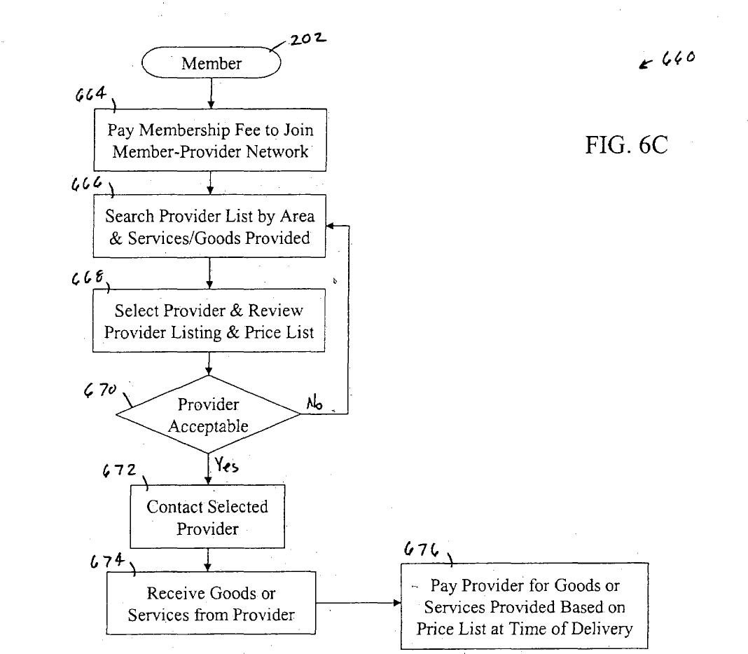

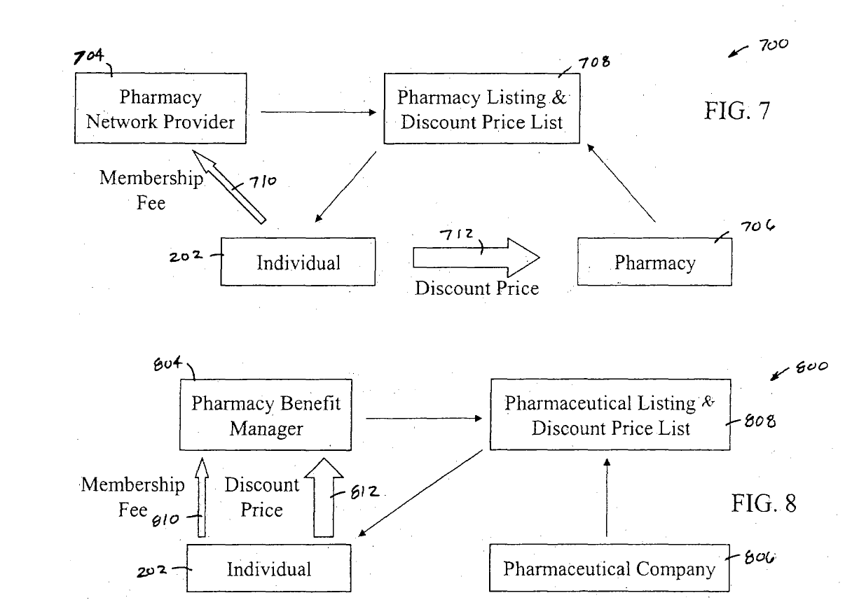

Referring now to FIG. 6A, a flow chart showing the steps 600 performed by a network provider 204 in accordance with one embodiment of the present invention (FIGS. 2A and 7) is shown. The network provider 204 and/or PPO BUSTERS receives membership fees from new and renewing members in block 604, receives premium listing fees and information, which include price list information, from the appropriate medical service/good providers in block 606, receives basic listing information, which includes price list information, from the appropriate medical service/good providers in block 608, and receives advertising fees from third parties in block 610. After the advertising fees are received in block 610, the network provider 204 places the advertisements in content that is provided to the members in block 612. After blocks 604, 606, 608 or 612, the network provider 204 provides the basic/premium listings and price lists to the members in block 614, receives and processes feedback from members, medical service/good providers and advertisers in block 616 and periodically updates the information provided to the members in block 618.

Now referring to FIG. 6B, a flow chart showing the steps 630 performed by a medical service/good provider 206 in accordance with one embodiment of the present invention (FIGS. 2A and 7) is shown. The medical service/good provider 206 joins the member-provider network in block 634. If the medical service/good provider 206 does not agree to an existing discount price list, as determined in decision block 636, the medical service/good provider 206 submits a discount price list in block 638. Once the price list is either agreed to, as determined in decision block 636, or submitted in block 638, the medical service/good provider 206 elects to have a basic or premium listing as determined in decision block 640. If the medical service/good provider 206 elects not to have a premium listing, as determined in decision block 640, the medical service/good provider 206 provides the necessary information to be included in the basic listing in block 642. If, however, the medical service/good provider 206 elects to have a premium listing, as determined in decision block 640, the medical service/good provider 206 pays the premium listing fee in block 644 and provides the desired information to be included in the premium listing in block 646. Once the listing information is complete (blocks 642 or 646), the medical service/good provider 206 provides goods or services to members in block 648 and receives payment for the goods or services provided based on the price list at time of delivery in block 650. As previously mentioned, the medical service/good provider 206 receives payment immediately from the member instead of waiting on and hassling with an insurance company.

Referring now to FIG. 6C, a flow chart showing the steps 660 performed by a member 202 in accordance with one embodiment of the present invention (FIGS. 2A and 7) is shown. The member 202 pays a membership fee to join the member-provider network in block 664. When the member 202 needs medical services or goods, he or she searches the medical service/good provider list using various well known criteria, such as area and services/goods provided, in block 666. The member 202 then selects a medical service/good provider and reviews the listing (basic or premium) and price list for the selected medical service/good provider in block 668. If the medical service/good provider is acceptable, as determined in decision block 670, the member 202 contacts the selected medical service/good provider in block 672. If, however, the medical service/good provider is not acceptable, as determined in decision block 670, the member 202 can narrow the search parameters or perform a new search in block 666 and repeats the process. Once the member 202 contacts the medical service/good provider in block 672, the member 202 receives the goods or services from the medical service/good provider in block 674 and pays the medical service/good provider for the goods or services provided based on the price list at the time of delivery in block 676.

Now referring to FIG. 7, a diagram illustrating PPO BUSTERS 700 provided by a pharmacy network provider, which may include a group of retail or wholesale drug stores, or pharmaceutical companies, etc., in accordance with another embodiment of the present invention is shown. This embodiment of PPO BUSTERS 700 includes a pharmacy network provider 704, individuals 202 and pharmacies 706. Individuals 202 pay a membership fee 710, typically per person/family per month/year, to the pharmacy network provider 704 and/or PPO BUSTERS in order to join the program and access the pharmacy listing and discount price list 708. All or part of the membership fee 710 may be paid by the individual's 202 employer or business. The membership fee 710 may also include coverage for a spouse and dependents. The pharmacy listing 708 is created and maintained by the pharmacy network provider 704 or its agents and contains, in part, information provided by the pharmacies 706. The pharmacies 706 provide this information to the pharmacy network provider 704 when they join PPO BUSTERS by agreeing to the terms and conditions of the pharmacy network provider 704, such as agreeing to only charge individuals 202 of PPO BUSTERS the discount price 712. The individual 202 pays the discount price 712 to the pharmacy 706 when the goods or services are rendered. The individual 702 can “look up” the discount price on the discount price list 708 prior to contacting the pharmacy 706.

Flow charts illustrating this embodiment of the present invention are the same as previously described FIGS. 6A, 6B and 6C wherein the following references are equivalent to one another: members 202 (FIGS. 6A, 6B and 6C) and individuals 202 (FIG. 7); network provider 204 (FIGS. 6A, 6B and 6C) and pharmacy network provider 704 (FIG. 7); and service/good provider 206 (FIGS. 6A, 6B and 6C) and pharmacy 706 (FIG. 7). In addition, this embodiment of the present invention includes designing a pricing schedule of all the drugs offered at a discount through participating pharmacies. Once the drug schedules are developed, a premium listing may be sold for each specific drug listed on the web site and/or link to the website of the drug company that manufactures the product (see blocks 606 through 614 in FIG. 6A), which would act as a full page advertisement on the actual drug itself or about the drug manufacturer. These particular premium drug listings would be sold at a rate based on the value of a targeted market demographic audience thus allowing individual drug companies to aggressively market their drugs to targeted consumers.

For example, FIG. 8 illustrates PPO BUSTERS 800 provided by a pharmacy benefit manager 804, which is typically a managed volume purchaser of drugs, in accordance with another embodiment of the present invention. This embodiment of PPO BUSTERS 800 includes a pharmacy benefit manager 804, individuals 202 and pharmaceutical companies 806. Individuals 202 pay a membership fee 810 to the pharmacy benefit manager 804 and/or PPO BUSTERS in order to join the program and access the pharmaceutical listing and discount price list 808. All or part of the membership fee 810 may be paid by the individual's 202 employer or business. The membership fee 810 may also include coverage for a spouse and dependents. The pharmaceutical listing 808 is created and maintained by the pharmacy benefit manager 804 or its agents and contains, in part, information provided by the pharmaceutical companies 806, which could join PPO BUSTERS 800 in order to get preferential treatment. The individual 202 pays the discount price 812 to the pharmacy benefit manager or its designated pharmacies 804 when the goods or services are rendered. The individual 202 can “look up” the discount price on the discount price list 808 prior to contacting the pharmacy benefit manager or its designated pharmacies 804.

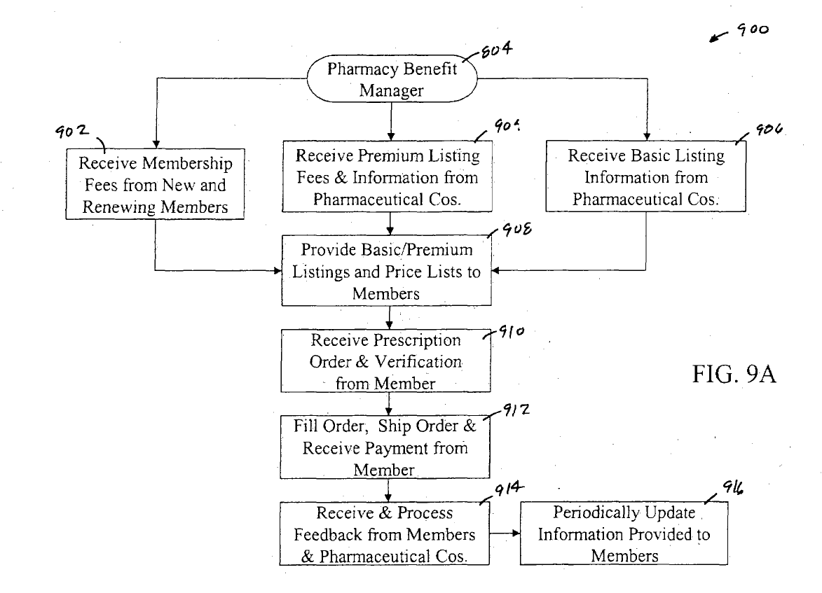

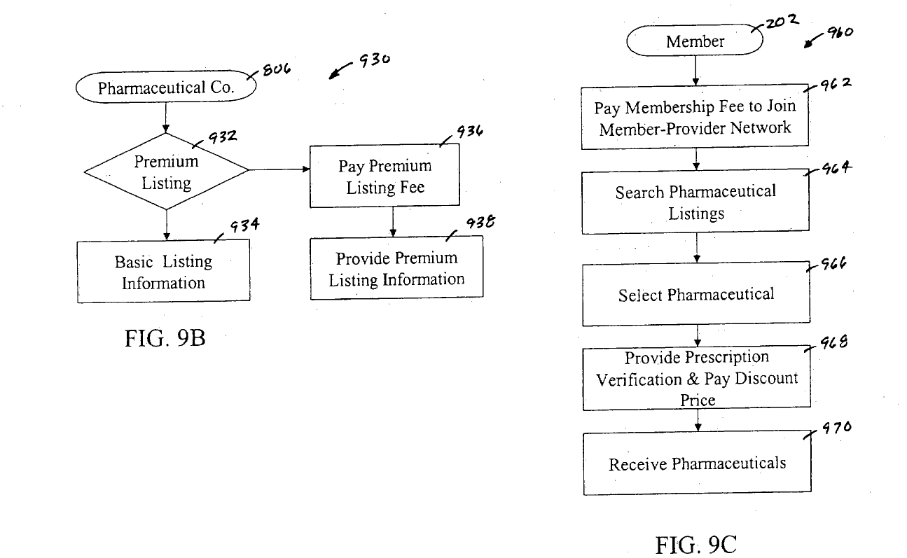

Now referring to FIG. 9A, a flow chart showing the steps 900 performed by a pharmacy benefit manager 804 in accordance with another embodiment of the present invention (FIG. 8) is shown. The pharmacy benefit manager 804 and/or PPO BUSTERS receives membership fees from new and renewing members in block 902, receives the premium listing fees and information, which include price list information, from the appropriate pharmaceutical company in block 904, and receives the basic listing information, which includes price list information, from the appropriate pharmaceutical company in block 906. After blocks 902, 904 or 906, the pharmacy benefit manager 804 provides the basic/premium listings and price lists to the members in block 908, receives prescription order and verification information from the member in block 910 and fills the order, ships the order and receives payment from the member in block 912. The order and payment process can be accomplished using the Internet, a dial up service, express delivery service or mail. Alternatively, the member can take the prescription to a branch or authorized agent of the pharmacy benefit manager 804 to receive and pay for the pharmaceuticals. Thereafter, the pharmacy benefit manager 804 receives and processes feedback from members and pharmaceutical companies in block 914 and periodically updates the information provided to the members in block 916.

Referring now to FIG. 9B, a flow chart showing the steps 930 performed by a pharmaceutical company 806 in accordance with another embodiment of the present invention (FIG. 8) is shown. The pharmaceutical company 806 may agree to special pricing and/or elect to have a basic or premium listing as determined in decision block 932. If the pharmaceutical company 806 elects not to have a premium listing, typically on a per drug basis, as determined in decision block 932, the pharmaceutical company 806 provides the necessary information to be included in the basic listing in block 934. If, however, the pharmaceutical company 806 elects to have a premium listing, as determined in decision block 932, the pharmaceutical company 806 pays the premium listing fee in block 936 and provides the desired information to be included in the premium listing in block 938.

Now referring to FIG. 9C, a flow chart showing the steps 960 performed by a member 202 in accordance with another embodiment of the present invention (FIG. 8) is shown. The member 202 pays a membership fee to join the pharmacy benefit manager 804 and/or PPO BUSTERS in block 962. When the member 202 needs pharmaceuticals, he or she searches the pharmaceutical list, which includes listings, educational information and pricing, using various well known criteria in block 964. The member 202 then selects a pharmaceutical in accordance with a prescription and reviews the listing (basic or premium) and price list for the selected pharmaceutical in block 966. In addition, the member 202 can use the present invention to research drugs and pharmaceutical companies prior to or after seeing a health care provider. The member 202 then provides prescription verification and information to the pharmacy benefit manager and pays the discount price in block 968 and receives the pharmaceuticals in block 970. The order and payment process can be accomplished using the Internet or a dial up service. Alternatively, the member 202 can take the prescription to a branch or authorized agent of the pharmacy benefit manager to receive and pay for the pharmaceuticals.

Referring now to FIG. 10, a diagram illustrating a PPO/major medical plan 1000 provided by an insurance company 1002 in accordance with another embodiment of the present invention is shown. PPO BUSTERS 1000 includes an insurance company 1002 that provides major medical and is the network provider, individuals 202 and medical service/good providers 206. As previously described, individuals 202 pay a membership fee 1006 to the insurance company 1002 and/or PPO BUSTERS in order to join the program and access the medical service/good provider listing and discount price list 1012. The individual 202 can also pay a major medical premium 1004 to the insurance company 1002. Note that the membership fee 1006 and the major medical premium 1004 can be combined into single or periodic payments. In addition, all or part of the membership fee 1006 and major medical premium 1004 may be paid by the individual's 202 employer or business. The membership fee 1006 and major medical premium 1002 may also include coverage for a spouse and dependents. The medical service/good provider listing 1012 is created and maintained by the insurance company 1002 or its agents and contains, in part, information provided by the medical service/good providers 206. The medical service/good providers 206 provide this information to the insurance company 1002 when they join PPO BUSTERS by agreeing to the terms and conditions of the insurance company 1002, such as agreeing to only charge individuals 202 of PPO BUSTERS the discount price 1008. The individual 202 pays the discount price 1008 to the medical service/good provider 206 when the goods or services are rendered. The individual 202 can “look up” the discount price on the discount price list 1012 prior to contacting the medical service/good provider 206. Once the deductible is reached, the insurance company 1002 then pays the medical service/product provider 206 based on what is deemed as usual and customary charges (Major Medical Payment 1010) for the product or service in the particular geographic area.

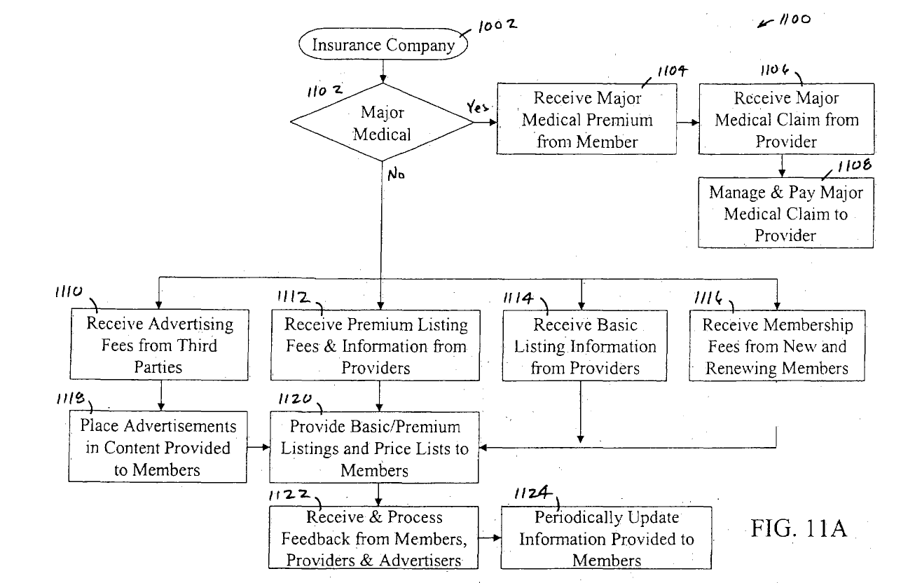

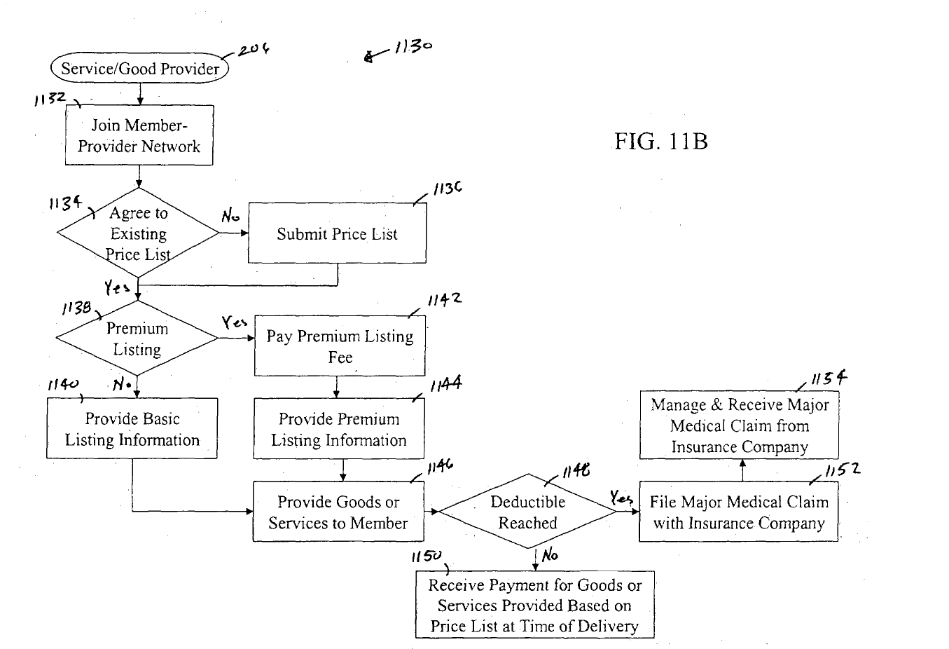

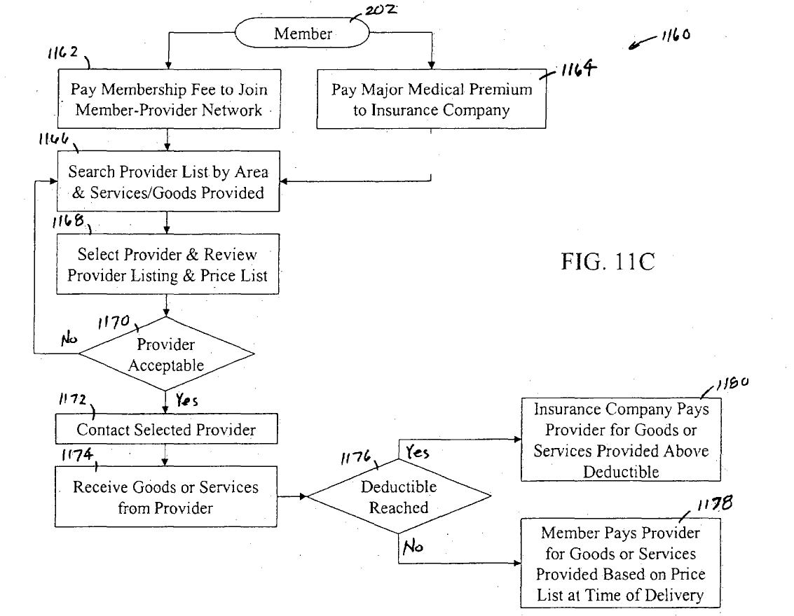

Now referring to FIG. 11A, a flow chart showing the steps 1100 performed by an insurance company 1002 in accordance with another embodiment of the present invention (FIG. 10) is shown. With respect to the major medical part of the plan, as determined in decision block 1102, the insurance company 1002 receives major medical premiums from the member in block 1104. Thereafter, the insurance company 1002 will periodically receive major medical claims for a member from a medical service/good provider in block 1106. The insurance company 1002 then manages and pays the major medical claim to the medical service/good provider in block 1108. With respect to the PPO BUSTERS part of the plan, as determined in decision block 1102, the insurance company 1002 and/or PPO BUSTERS receives membership fees from new and renewing members in block 1110, receives the premium listing fees and information, which include price list information, from the appropriate medical service/good providers in block 1112, receives the basic listing information, which includes price list information, from the appropriate medical service/good providers in block 1114, or receives advertising fees from third parties in block 1116. After the advertising fees are received in block 1110, the insurance company 1002 places the advertisements in content that is provided to the members in block 1118. After blocks 1112, 1114, 1116 or 1118, the insurance company 1002 provides the basic/premium listings and price lists to the members in block 1120, receives and processes feedback from members, medical service/good providers and advertisers in block 1122 and periodically updates the information provided to the members in block 1124.

Referring now to FIGURE 11B, a flow chart showing the steps 1130 performed by a medical service or good provider 206 in accordance with another embodiment of the present invention (FIG. 10) is shown. The medical service/good provider 206 joins the member-provider network in block 1132. If the medical service/good provider 206 does not agree to an existing discount price list, as determined in decision block 1134, the medical service/good provider 206 submits a discount price list in block 1136. Once the price list is either agreed to, as determined in decision block 1134, or submitted in block 1136, the medical service/good provider 206 elects to have a basic or premium listing as determined in decision block 1138. If the medical service/good provider 206 elects not to have a premium listing, as determined in decision block 1138, the medical service/good provider 206 provides the necessary information to be included in the basic listing in block 1140. If, however, the medical service/good provider 206 elects to have a premium listing, as determined in decision block 1138, the medical service/good provider 206 pays the premium listing fee in block 1142 and provides the desired information to be included in the premium listing in block 1144. Once the listing information is complete (blocks 1140 or 1144), the medical service/good provider 206 provides goods or services to members in block 1146. If the goods or services are covered by the PPO BUSTERS part of the plan because the deductible has not been reached, as determined in decision block 1148, the medical service/good provider 206 receives payment for the goods or services provided from the member based on the price list at time of delivery in block 1150. As previously mentioned, the medical service/good provider 206 receives payment immediately from the member instead of waiting on and hassling with an insurance company. If, however, the goods or services are covered by the major medical part of the plan because the deductible has been reached, as determined in decision block 1148, the medical service/good provider 206 files a major medical claim with the insurance company in block 1152. The medical service/good provider 206 then manages and ultimately receives payment for the major medical claim from the insurance company in block 1154.

Now referring to FIG. 11C, a flow chart showing the steps 1160 performed by a member 202 in accordance with another embodiment of the present invention (FIG. 10) is shown. With respect to the PPO BUSTERS part of the plan, the member 202 pays a membership fee to join the member-provider network in block 1162. With respect to the major medical part of the plan, the member 202 pays major medical premiums to the insurance company in block 1164. When the member 202 needs medical services or goods, he or she searches the medical service/good provider list using various well known criteria, such as area and services/goods provided, in block 1166. The member 202 then selects a medical service/good provider and reviews the listing (basic or premium) and price list for the selected medical service/good provider in block 1168. If the medical service/good provider is acceptable, as determined in decision block 1170, the member 202 contacts the selected medical service/good provider in block 1172. If, however, the medical service/good provider is not acceptable, as determined in decision block 1170, the member 202 can narrow the search parameters or perform a new search in block 1166 and repeats the process. Once the member 202 contacts the medical service/good provider in block 1172, the member 202 receives the goods or services from the medical service/good provider in block 1174. If the member's deductible has not been reached, as determined in decision block 1176, the member 202 pays the medical service/good provider for the goods or services provided based on the price list at the time of delivery up to the member's annual deductible amount in block 1178. If, however, the goods or services are covered by the major medical part of the plan because the deductible has been reached, as determined in decision block 1176, the insurance company pays the medical service/good provider for the goods or services provided that exceed the member's deductible. Note that the member's deductible may include a per visit deductible, 80%/20% deductible and/or maximum out-of-pocket expense cap.

As referenced earlier, there appears currently an unprecedented opportunity to have a significant influence on the medical services industry in this country and capture a large portion of that industry's business, while providing both the doctors and patients of that industry a tremendous service. PPO Busters is the solution and methodology to bring this opportunity to fruition.

While this invention has been described in reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A system comprising:
a network provider that provides a health care plan;
one or more medical service/good providers that have joined the health care plan;
one or more individuals that are members of the health care plan; and
a discount price list provided by the network provider that regulates the cost of services/goods provided to the members by the medical service/good providers such that the members pay the medical service/good providers in-full directly for any services/goods rendered based on the discount price list.

2. The system as recited in claim 1, wherein the discount price list is a variable discount price list that tracks a known standard service price list.

3. The system as recited in claim 1, wherein the individuals pay a membership fee to the network provider to join the health care plan.

4. The system as recited in claim 3, wherein the membership fee is paid by the individual's employer.

5. The system as recited in claim 3, wherein the membership fee is paid by the individual's business.

6. The system as recited in claim 3, wherein the membership fee is a renewal fee.

7. The system as recited in claim 1, wherein the member includes his/her family in the health care plan.

8. The system as recited in claim 1, wherein the medical service/good providers are selected from the group consisting of physicians, hospitals, physical therapists, nursing facilities, cancer treatment centers, optical and hearing aid dispensaries, hospices, clinics, pharmacies, chiropractors, dentists, medical supply stores, hospital supply stores and handicap equipment suppliers.

9. The system as recited in claim 1, wherein the medical service/good provider is a doctor that works for a corporation.

10. The system as recited in claim 1, further comprising a medical service/good provider listing provided by the network provider to the members.

11. The system as recited in claim 10, wherein the medical service/good provider listing comprises basic listings and premium listings.

12. The system as recited in claim 11, wherein the basic listings are provided to medical service/good providers free of charge.

13. The system as recited in claim 11, wherein the premium listings are provided to medical service/good providers upon payment of a premium listing fee.

14. The system as recited in claim 13, wherein the premium listings include a link to a customizable web page for the medical service/good providers that is accessible via a global telecommunications network.

15. The system as recited in claim 13, wherein the premium listings include a link to the medical service/good provider's web site.

16. The system as recited in claim 13, wherein the premium listings are customized for each medical service/good provider.

17. The system as recited in claim 10, wherein the discount price list and the medical service/good provider listing is accessible via a global telecommunications network.

18. The system as recited in claim 10, wherein the discount price list and the medical service/good provider listing are searchable by the members using one or more search criteria.

19. The system as recited in claim 18, wherein one of the search criteria is based on geographic area

20. The system as recited in claim 18, wherein one of the search criteria is based on the services and goods provided by the medical service/good providers.

21. The system as recited in claim 1, further comprising one or more advertisements provided by the network provider to the members.

22. The system as recited in claim 21, wherein an advertiser pays the network provider an advertising fee to provide the advertisements to the members.

23. The system as recited in claim 21, wherein the advertisement provided to a member is based on one or more search criteria used to search the medical service/good provider listing.

24. The system as recited in claim 1, wherein the network provider is an insurance provider.

25. The system as recited in claim 24, wherein the insurance provider provides members with major medical insurance in return for payment of one or more major medical premiums.

26. A method for providing a health care plan comprising the steps of:
receiving a membership fee from one or more individuals to become members of the health care plan;
obtaining information from one or more medical service/good providers that have joined the health care plan; and
providing a discount price list that regulates the cost of services/goods provided to the members by the medical service/good providers such that the members pay the medical service/good providers in-full directly for any services/goods rendered based on the discount price list.

27. A computer program embodied on a computer readable medium for providing a health care plan comprising:
a code segment for receiving a membership fee from one or more individuals to become members of the health care plan;
a code segment for obtaining information from one or more medical service/good providers that have joined the health care plan; and
a code segment for providing a discount price list that regulates the cost of services/goods provided to the members by the medical service/good providers such that the members pay the medical service/good providers in-full directly for any services/goods rendered based on the discount price list.

28. An apparatus for providing a health care plan comprising:
a server;
one or more storage devices communicably coupled to the server, the one or more data storage devices containing a discount price list that regulates the cost of services/goods provided to a member of the health care plan by a medical service/good provider such that the member pays the medical service/good provider in-full directly for any services/goods rendered based on the discount price list;
a communications interface communicably coupled to the server that allows a member to access the discount price list; and
wherein the member is an individual that has paid a membership fee to join the health care plan.
